SEQUENCE LISTING (2 sequences)

SEQ ID NO: 1 - DNA, 28 bp, Artificial
  Synthetic sequence to illustrate the steps of similarity assessment.
aagcgatttgcttgctttgacctcccaa

SEQ ID NO: 2 - DNA, 84 bp, Artificial
  Synthetic sequence to illustrate the steps of similarity assessment.
cgtgagacagaaacgtctgctgtttcagccacccaggttgtggtatttcattatggcattcccaagctcactaagataacaaga

(19) United States
(12) Patent Application Publication
(10) Pub. No.: US 2013/0091121 A1
(43) Pub. Date: Apr. 11, 2013

(54) Method for rapid assessment of similarity between sequences

(71) Applicant: Vitaly L. GALINSKY, San Diego, CA (US)

(72) Inventor: Vitaly L. GALINSKY, San Diego, CA (US)

(21) Appl. No.: 13/543,663

(22) Filed: Jul. 6, 2012

Related U.S. Application Data
(60) Provisional application No. 61/521,454, filed on Aug. 9, 2011.

(51) Int. Cl. G06F 19/22

(52) U.S. Cl. CPC G06F 19/22
USPC 707/715

(57) ABSTRACT

Genomic sequence matching and alignment techniques are disclosed. In one embodiment, an index of a reference sequence is constructed that represents all transitions from a single l-mer prefix to multiple m-mer suffixes. This index data structure may take a variety of forms, including an array or a tree. The base position of each transition from l-prefix to m-suffix is recorded in k-bit masked form. The positions data structure may take a variety of forms as well, including an array or a tree. The l-prefix, m-suffix and k-position index is used for rapid assessment of similarity between a query and a reference genomic sequence by means of a table of local hits.

The current application claims a priority to the U.S. Provisional Patent application Ser. No. 61/521,454 filed on Aug. 9, 2011.

### FIELD OF THE INVENTION

The present invention relates to the comparison of biological sequences and, more specifically, the invention relates to a method, a computer readable device, and an electronic device for rapid screening of local sequence similarity in accordance with the claims.

### BACKGROUND OF THE INVENTION

It is frequently desired to compare two sequences for the purpose of determining similar portions of these sequences. Searching databases for sequences similar to a given sequence is probably one of the most fundamental and important tools for predicting structural variations and functional properties in the modern biology.

The rapidly increasing amounts of genetic sequence information available represent a constant challenge to developers of hardware and software database searching and handling. The expansion of an amount of the genetic sequence information happens at a rate that exceeds the growth in computing power available at a constant cost, in spite of the fact that computing resources also have been increasing exponentially for many years. If this trend continues, increasingly longer time or increasingly more expensive computers or other resources will be needed to search the entire database.

Searching for similarity includes introducing “gaps” into a query sequence, a reference sequence, or both sequences that optimize the amount of similarity. When looking for sequences in a database similar to a given query sequence, the search programs compare the query sequence (with unknown distribution of gaps) to every subsequence in the database (again with unknown distribution of gaps). The availability of good tools for performing rapid similarity screening is hence extremely important.

The typical current approach for similarity search is based on calculating an alignment of the two sequences using a substitution score matrix and a gap penalty function. A dynamic programming algorithm for computing the optimal local alignment was first described by Smith and Waterman (1981). See T. F. Smith and M. S. Waterman, Identification of Common Molecular Subsequences, J. Mol. Biol. (1981) 147, 195-97. Sequence matching is commonly performed on very long sequences, and the currently emerging single molecule sequencing technologies are constantly pushing read lengths into longer and longer realm, with 100K or 1M base pairs queries are not a fantasy. Thus efficiently aligning long reads (more than 200 bp) against a long reference sequence (more than 1 Gb, like e.g. the human genome) is becoming an urgent demand for the development of alignment tools.

In contrast to short-read (less than 100 bp) alignment when the best match is deduced by the end-to-end mapping of the query to the reference that minimizes a number of mismatches, long-read alignment is often based on several local matches and thus is being able to detect both structural variations in the query and erroneous assemblies in the reference. Additionally, short-read aligners are optimized for ungapped alignment and introduction of even limited number of short (several base pairs) gaps imposes heavy performance penalties on these short-read algorithms. Long-read aligners on the contrary should be able (and optimized) to deal with arbitrary number of gaps of arbitrary size each.

The majority of currently available long-read alignment methods may be classified as either using hash table indexing, like in BLAT (Kent, 2002) or in SSAHA2 (Ning et al., 2001), or using some sort of compressed trie indexing based on Burrows-Wheeler transform (BWT) (Burrows and Wheeler, 1994), for example, in BWT-SW (Lam et al., 2008) or in BWA-SW (Li and Durbin, 2010). But in spite of using different indexing strategies, all the above long alignment algorithms follow the seed-and-extend paradigm, i.e. they first search for one or more of the so called seeds (either short exact matches, as in SSAHA2 and BLAT, or longer gapped matches in unique regions, as in BWASW). The found seeds are then extended to cover the whole query sequence using the Smith-Waterman algorithm (BWA-SW uses this algorithm for identifying long gapped seeds as well). This extension algorithm is computationally expensive and the resulting toll remains heavy. Performance using the Smith-Waterman algorithm is very computationally intensive—on the order of M×N operations (denoted as “O(MN)” complexity), where M and N are the lengths of the two sequences being matched. As a result, the use of the Smith-Waterman algorithm is not practical in many instances. A less computationally intensive method for sequence matching is therefore highly desired.

U.S. Pat. No. 7,917,302 B2 (Rogues) discloses a method for an efficient parallelization of the Smith-Waterman sequence alignment algorithm using parallel processing in the form of SIMD (Single-Instruction, Multiple-Data) technology. The method still has O(MN) complexity both in time and in space, and hence, not practical for high throughput applications.

U.S. Pat. No. 2009/0125514 A1 (Brown) discloses sequence alignment techniques that introduce a sparse data structure for the Smith-Waterman matrix. This method provides logarithmic improvement for the time complexity O((M+N)log(M)), and because typically

N>>M, that method may still be not sufficient for large sequence databases. For example, for human genomic sequence alignment with N being more than 3 billion characters and M=100, the improvement is about 100/log(100)=21.7, but at the expense of losing some of the true alignments.

“Fast and accurate long-read alignment with Burrows-Wheeler transform” (Li, H. and Durbin, R.) discloses a Burrows-Wheeler Aligner's Smith-Waterman Alignment (BWA-SW) method to align long sequences against a large sequence database (e.g. the human genome). The method adds several heuristics accelerations to the Smith-Waterman algorithm and is able to reduce the time complexity of the algorithm to the sub quadratic level O(N^{0.628}M) and again at the expense of losing some of the true alignments.

Accordingly, what is desired, and not heretofore been developed, is a writing alignment tool wherein the total time complexity would be reduced and completely independent from the large size of the reference database. Furthermore, what is desired, and not heretofore been developed, is a writing alignment tool that allows rapid assessment of a similarity between genomic sequences in a linear time O(M).

### BRIEF SUMMARY OF THE INVENTION

This invention is related to bioinformatics and biological data analysis. Specifically, this invention provides methods, computer software products and systems for assessment of similarity between genomic (DNA or RNA) sequences. In preferred embodiments, the methods, computer software products and systems are used for high throughput processing of vast amount of genomic reads (queries) against very large genomic database (reference), which is aligning queries to the reference.

It is an object of the present invention to provide a method for rapid assessment of similarity between query and reference genomic sequences wherein the reference sequence is ultimately represented by an index. This index data structure may take a variety of forms, including an array or a tree.

In another embodiment, a method is provided for building several indices, including forward and backward index or indices. This index data structure may take a variety of forms, including gapless subsequences or subsequences with gaps. A method is provided to apply these indices in concert in order to increase the query sensitivity and error tolerance.

In another embodiment, a method provides a means of effective compression of the reference index database, both in computer memory and on computer disk, as well as a means of in place querying of the reference index for obtaining the positions of all occurrences of the entire query or any part of it in the reference sequence. The time complexity of position retrieval provided by preferred embodiments does not depend on the size of the reference database.

In preferred embodiments, methods are provided for analyzing the results of the sequential processing of the genomic query against the reference database by means of building of local hit table that includes positions of all similarities between each query subsequence (l base pairs prefix and m base pairs suffix) in the reference database. The time complexity of local hit table building provided by preferred embodiments depends linearly on the size of the query.

In some preferred embodiments, the methods include merging the local hits in the table that correspond to the same alignment and obtaining gaps and structural variations data in the merging process.

In another aspect of the invention, systems, and computer software are provided for performing the methods of the invention. The systems include a processor; and a memory coupled with the processor, the memory storing a plurality of machine instructions that cause the processor to perform logical steps of the methods of the invention. The computer software products of the invention include a computer readable medium having computer-executable instructions for performing the method of the invention.

### BRIEF DESCRIPTION OF THE DRAWINGS

FIG. 1 illustrates an index building step of the new approach. The arrows indicate the index direction in transition from l base pairs prefix to m base pairs suffix, forward being left to right and backward being right to left. Tables at each transition contain all recorded positions in the reference sequence (SEQ ID NO: 1) with dark bold corresponding to k-bit masked part. Current position is underlined.

FIG. 2 illustrates pseudo-code for the index build step of the new approach, the pseudo-code being just a detailed example showing how the method may be implemented in a computer program.

FIG. 3 illustrates a query processing step and a building of a table of local hits between query (SEQ ID NO: 2) and reference.

FIG. 4 illustrates pseudo-code for the query processing step of the new approach, the pseudo-code being just a detailed example showing how the method may be implemented in a computer program.

FIG. 5 illustrates a query processing step and a building of a table of local hits between a query and a reference for the query (SEQ ID NO: 2) with five base pairs gap.

FIG. 6 illustrates an example of a computer system that may be used to execute the software of an embodiment of the invention.

FIG. 7 illustrates one embodiment of internal composition of a computer system that may be used to implement the above-described methods.

### DETAILED DESCRIPTION OF THE INVENTION

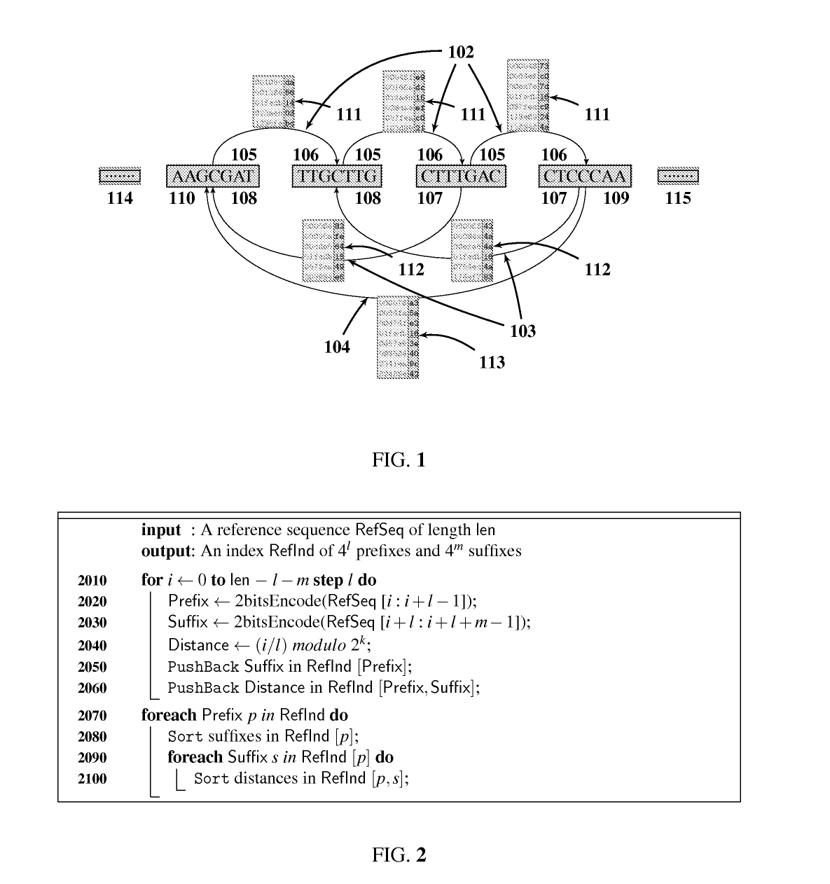

The preferred embodiment will be described with reference to the drawings. The method starts with building several forward 102 and backward indices (103, 104) for the reference sequence (SEQ ID NO: 1) as shown in FIG. 1. The indices are organized in list type structures to combine the advantages of both hash based and trie based methods. FIG. 1 shows the schematic diagram of an intermediate single step of index building, ignoring leading 114 and trailing 115 parts of the reference sequence. The forward index 102, shown above the sequence, is organized as a lexicographically sorted array of l base pairs prefixes 105. Each prefix entry 105 is pointing to a lexicographically sorted array of m base pairs suffixes 106, as shown by left to right directed arrows 102. In turn, each suffix entry 106 is associated with a numerically sorted array of l scaled k-bit masked locations 111 (i.e. locations/l modulo 2^{k}) of each of these l+m base pairs indexed entries, as shown by tables touching the arrows 111. An optimal choice of l, m, k parameters probably depends on a size and a composition of reference sequence, but for human genome with around 3 billion base pairs the parameters l=m=7 base pairs and k=8 bit seem to work rather well and were adopted as a feasibility checkpoint in all the results reported below using test implementation. Size of this index for the human genome is roughly 3 billion base pairs/7 base pairs×8 bit≈400 MB.

The purpose of splitting l+m by indices into l-bp prefix and m-bp suffix is not just for conserving memory. Both the prefix and the suffix parts are lexicographically sorted, therefore, they provide not only an index (or hash), but also can work as a forward or backward tree, thus allow fast unwinding of low complexity/low error rate regions. An adaptation of k=8 bit mask to store the locations naturally creates compressed index, as many highly repetitive parts of the reference will be collapsed into a single index entry with the same prefix, suffix and masked location.

Below the sequence FIG. 1 shows two backward indices (103, 104), each with left to right arrows pointing from l base pairs prefix (107,109) to m base pairs suffix (108,110). Again each suffix entry (108,110) is associated with a numerically sorted array of l scaled k-bit masked locations (112,113) (i.e. locations/l modulo 2^{k}) of each of these l+m base pairs indexed entries, as shown by tables touching the arrows (112,113). To increase the sensitivity of index searches the backward indices contain gaps to be able to produce hits when several errors are clamped in the middle sections of the query sequence. These clamped errors won't allow producing any hits with consecutive forward index. A better choice would be to build two backward indices with gaps (as was implemented). One backward index 103 contains l base pairs gap and the second 104 contains 2l base pairs gap (as shown at the bottom of FIG. 1). As a result, these three indices (one forward and two backward) applied in concert will produce at least one hit for any 4×l subsequence with 2 or less single base errors, that is with uniform error density of≈7% or less for l=7.

An adaptation of k bit mask to store the locations (111,112,113) naturally creates compressed index, as many highly repetitive parts of the reference will be collapsed into a single index entry with the same prefix, suffix and masked location.

FIG. 2 shows a pseudo-code of the index building step, that includes a loop over a reference sequence 2010 to extract l overlapped l+m base pairs subsequences. Each subsequence split in binary encoded (2bitsEncode) l base pairs prefix 2020 and m base pairs suffix 2030 and their values are saved 2050. A position of the subsequence in the reference are scaled by l with k-bit mask applied afterwards 2040. Arrays of suffixes and positions are sorted lexicographically 2080 and numerically 2100.

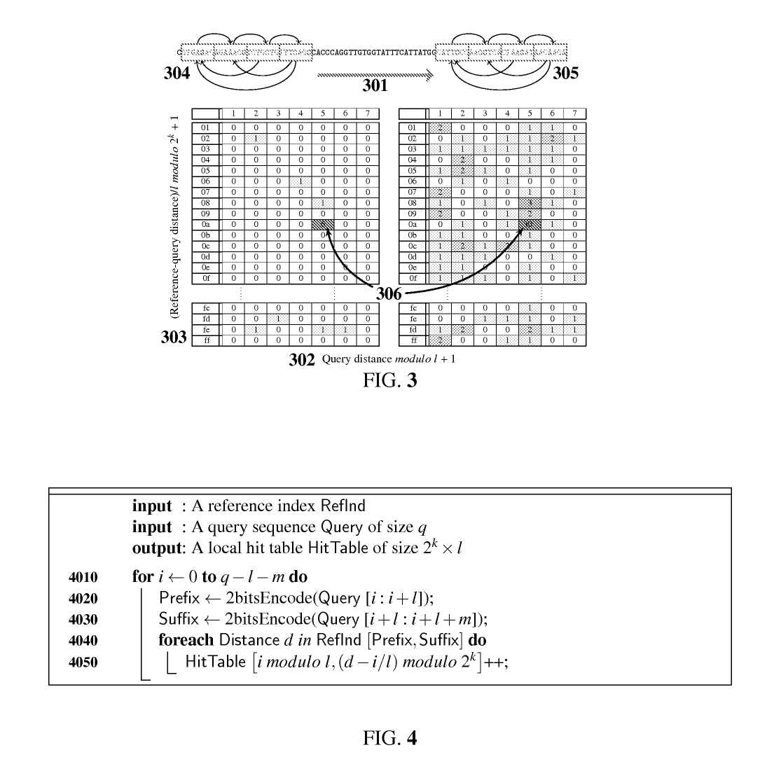

FIG. 3 shows the process of finding all local similarities 301 between a query and a reference sequence, which starts with recording of all local hits between them. The hits are organized in a table by a distance in a query (modulo l) 302 versus a difference in distances in a reference and in a query (scaled by l and modulo 2^{k}) 303. A size of this table depends on the choice of parameters l, m and k and can be expressed as l×2^{k}, where 7×256 table is shown in FIG. 3. Two states of the local hit table are shown: at the beginning 304 and the end 305 of processing of the query sequence (SEQ ID NO: 2). The cells with the highest numbers 306 correspond to significant similarities between the query and the reference. The second table (not shown) is filled up for the reverse compliment query sequence.

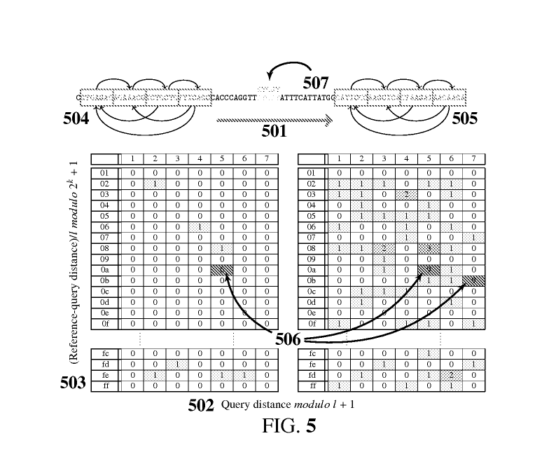

FIG. 4 shows a pseudo-code of the local hit table building step, which includes a loop over a query sequence 4010, to extract l+m base pairs subsequences. Each subsequence split in binary encoded (2bitsEncode) l base pairs prefix 4020 and m base pairs suffix 4030 and their values are used to retrieve numerically sorted array of l scaled k-bit masked reference locations 4040. This location array is used to update values in local hit table 4050. Size of this location array is 2^{k} and, therefore, the time complexity of the algorithm is O(2^{k} q), where q is the length of the query, i.e. for k=8 it is O(256q). An illustrative example that outlines the first 304 and the last 305 steps of filling typical hit table is shown in Figure FIG. 3 for human reference genome and q=84 base pairs query sequence. The hit table includes not only consecutive l+m-mer matches (14-mer in this case), but matches with l and 2l gaps as well. Therefore, the perfect match at the first step (in this case first 28 base pairs subsequence) should result in the total number of hits not less than 6 plus at least 3 new hits for each next perfectly matched l base pairs segment.

Number of hits(q)=6+3·((q−q mod l)/l−4)

Hence, for the perfect match of q=84 base pairs query sequence the hit table will contain at the last step 305 at least one entry with the number of hits equals to 30, as example in Figure FIG. 3 shows 306. Of course, presence of errors or single-nucleotide polymorphisms (SNPs) in a query sequence will decrease this number of hits, but on the contrary, multiple hits at the same 2^{k}-masked locations especially for highly repetitive subsequences will increase this number.

The entries with highest number of hits 306 will be candidates for the best alignment of the query to the reference. Presence of single well separated maximum in the hit table clearly indicates the unique alignment. For a set of chosen parameters (l=m=7 and k=8) a difference of 4 or 5 between max and second max entries in the hit table is good enough to rule out random hits that may arise due to rather short period of the l-scaled 2^{k}-masked location for k=8.

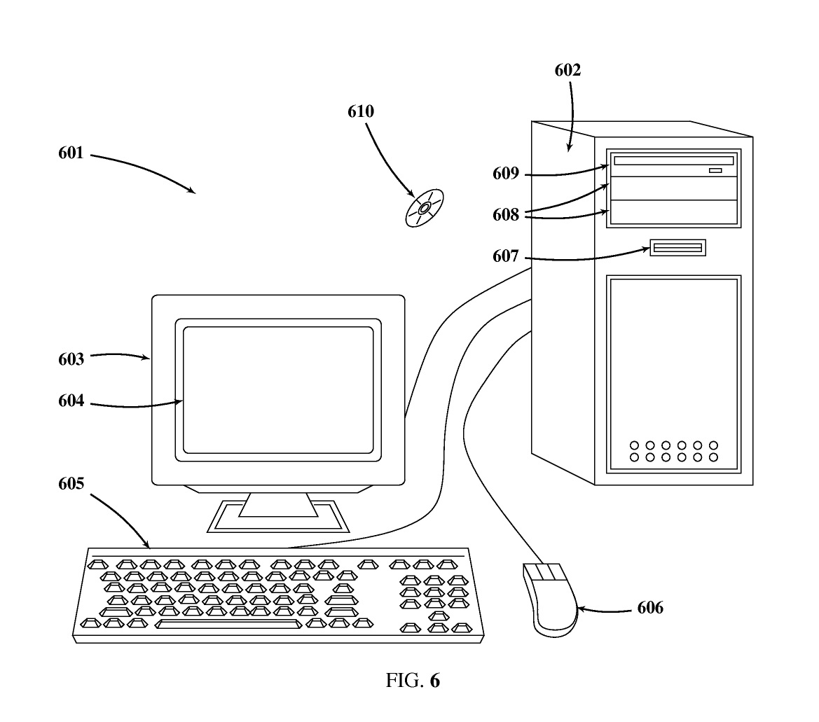

FIG. 5 illustrates how a construction of full local hit table 501 for the query sequence (SEQ ID NO: 2) creates rather convenient and straight forward way of searching for significant alignments with small but arbitrary gaps 507 as well as for detection of chimeric reads. The hits again are organized in a table by a distance in a query (modulo l) 502 versus a difference in distances in a reference and in a query (scaled by l and modulo 2^{k}) 503. The initial stage 504 of table construction is the same as for the gapless query sequence shown in FIG. 3, but for the final stage 505, FIG. 5 shows how the content of the table for the same 84 base pairs query sequence will be modified, if a small 5 base pairs deletion 507 is introduced. In this case the leading and the trailing portions of the sequence roughly of 40 base pairs each will produce two maximums with 3·((40−40 mod 7)/7−4)+6=9 hits 506 separated by 4 consecutive cells without hits or with low random hit counts.

The local hit table provides easy way of finding the total size of gap or gaps between local subalignments as well as types of these gaps (insertion or deletion) by analyzing the maximums that were formed at different 2^{k}-masked locations. In general, n bases deletion produces n−l empty cells in the right-left and then top-down direction with respect to the original cell. On the contrary, n bases insertion does it in the reverse, it adds n−l empty/low noise cells in the left-right down-top direction. For chimeric read the hit table will contain several maximums as well but the separation between them both by the 2k-masked location and by the full distance may in general be arbitrary large.

A simple greedy search algorithm has been implemented for selection of top hits from the local hit table. The algorithm first converts the two dimensional local hit table into linear buffer (circularly connected) following the right-left top-down pattern for the forward matches and the left-right top-down pattern for the reverse matches. The linear buffer entries is then partitioned in two classes, one corresponding to the possible hits and the second to the random background hits. Several rules are used for partitioning, the most important two rules are: three sigma rule (i.e. the entry is assumed to be a possible hit candidate, if it is separated by more than three sigma from the mean) and the maximum change rule (i.e. the entry is classified as a hit candidate, if it has number of hits larger than the entry with the biggest change in the sorted linear buffer). The set of hit candidates is then processed in greedy order, selecting the entry with largest number of hits, decoding the full reference position; using any three consecutive perfect matches from the list, unwinding low error regions (one or two base errors) using the reference index as a tree and scavenging the neighboring maxima in the local hit table that have correct encoded positions and hence may correspond to insertions or deletions. The process stops when a single entry is formed that clearly exceeds all other entries as well as the remaining hit candidates.

Presence of highly repetitive areas in the query sequence may complicate the search, especially when combined with errors, single-nucleotide polymorphisms (SNPs) or insertions/deletions. But input from repetitive regions tends to spread uniformly across many hit table entries and won't destroy the input from unique regions.

In another embodiment, acceleration is applied that involved introduction of additional hit table and filling both of the tables simultaneously going from the leftmost and the rightmost parts of the query towards each other. The process is terminated as soon as single ungapped or gapped entry in the run-time union of both tables can clearly be identified as a single significant alignment and the rest of the entries is at the level of noise created by random hits. When the query may be aligned at several locations, the algorithm will behave exactly like in non accelerated case and fill the complete local hit table up.

As the presently disclosed, method is good at detecting arbitrary gaps and chimeras, therefore it can also be used to facilitate detection of structural variations or reference misassembles.

An important difference of the disclosed method from various band accelerated modifications of the Smith-Waterman algorithm (that is from approaches maintaining a small fraction of the dynamic programming matrix and, hence, allowing better than O(rq) scaling at the expense of missing some of the possible matches, for example for gaps larger than chosen band size) is that it records all the local hits and therefore will not miss any of the true matches. It records all local hits between all l(prefix)+m(suffix) base pairs index entries for the reference sequence (organized as a forward and a backward tries) and all l+m base pairs subsequences (including l and 2l gapped) of the query sequence. The local hits are stored as a table of l-scaled modulo 2^{k} query subtracted location in the reference versus modulo l location in the query.

The overall complexity of this disclosed approach is bounded by the complexity of the local hit table building step, that is O(2^{k}q) (where q is the query length) or O(256q) for k=8 used in prototype implementation, hence it does not depend on the size r of the reference.

This method is designed to combine the advantages of both hash based and trie based algorithms. Similar to hash based algorithms it uses a series of look ups to build a correspondence between a query and a reference and, hence, has low associated computational overhead. Similar to compressed trie algorithms it compresses highly repetitive regions and suppresses short repetitive matches that poison the performance of hash based algorithms. The high accuracy, the low computational complexity as well as low memory requirements make the algorithm a candidate for specialty implementations with GPUs or FPGAs.

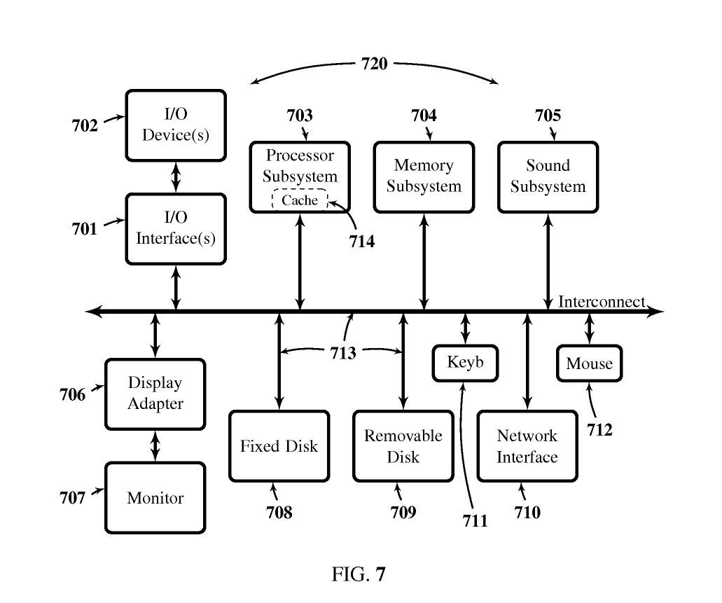

FIG. 6 illustrates an example of a computer system that may be used to execute the software of an embodiment of the invention. FIG. 6 shows a computer system 601 that includes a system block 602, display 603, screen 604, keyboard 605, and mouse 606. Mouse 606 may have one or more buttons for interacting with a graphic user interface. System block 602 houses a floppy drive 607, CD-ROM or DVD-ROM drive 609, system memory and a hard drive bf 608 (see also FIG. 7) which may be utilized to store and retrieve software programs incorporating computer code that implements the invention, data for use with the invention and the like. Although a CD 610 is shown as an exemplary computer readable medium, other computer readable storage media including floppy disk, tape, flash memory, system memory, and hard drive may be utilized. Additionally, a data signal embodied in a carrier wave (e.g., in a network including the Internet) may be the computer readable storage medium.

The sequence assessment embodiments described above may be performed on any suitable type of computer system, which includes any type of computing device. FIG. 7 illustrates one embodiment of a computer system 720 that may be used to implement the above-described methods. As shown, computer system 720 includes a processor subsystem 703 (which may have a cache 714 in one embodiment) that is coupled to a memory 704, sound subsystem 705 and I/0 interfaces(s) 701 via an interconnect 713 (e.g., a system bus). I/0 interface(s) 701 is coupled to one or more I/0 devices 702. Computer system 720 may be any of various types of devices, including, but not limited to, a personal computer system, desktop computer, laptop or notebook computer, mainframe computer system, hand-held computer, workstation, network computer, a consumer device such as a mobile phone, pager, or personal data assistant (PDA). Computer system 720 may also be any type of networked peripheral device such as storage devices, switches, modems, routers, etc. Although a single computer system 720 is shown in FIG. 7, system 720 may also be implemented as two or more computer systems operating together.

Processor subsystem 703 may include one or more processors or processing units. For example, processor subsystem 703 may include one or more multi-processor cores, each with its own internal communication and buses. In various embodiments of computer system 720, multiple instances of processor subsystem 703 may be coupled to interconnect 713. In various embodiments, processor subsystem 703 (or each processing unit within 703) may contain a cache 714 or other form of on-board memory.

Computer system 703 also contains memory 704 which is usable by processor subsystem 703. Memory 704 may be implemented using different physical memory media, such as hard disk storage, floppy disk storage, removable disk storage, flash memory, random access memory (SRAM, EDO RAM, SDRAM, DDR SDRAM, etc.), ROM (PROM, EEPROM, etc.), and so on.

As in FIG. 7, computer system 720 includes display adapter 706, monitor 707, keyboard 7011 and mouse 712. Computer system 720 further includes storage subsystems such as a fixed disk 708 (e.g., hard drive), removable storage 709 (e.g., floppy or CD-ROM). Computer system 720 may include sound subsystem 705 (e.g., speakers), and network interface 710. Other computer systems suitable for use with the invention may include either additional or fewer subsystems.

I/0 interfaces 701 may be any of various types of interfaces configured to couple to and communicate with other devices, according to various embodiments. In one embodiment, I/0 interface 701 is a bridge chip from a front-side to one or more back-side buses.

I/0 interfaces 701 may be coupled to one or more I/0 devices 702 via one or more corresponding buses or other interfaces. Examples of I/0 devices include storage devices (hard drive, optical drive, removable flash drive, storage array, storage area network, or their associated controller), network interface devices (e.g., to a local or wide-area network), or other devices (e.g., graphics, user interface devices, etc.)

Memory in computer system 720 is not limited to memory 704. Rather, computer system 720 may be said to have a “memory subsystem” that includes various types/locations of memory. For example, the memory subsystem of computer system 720 may, in one embodiment, include memory 704, cache 714 in processor subsystem 703, and storage on I/0 Devices 702 (e.g., a hard drive, storage array, etc.), fixed disk 708 or removable dist 709 directly connected to interconnect bus. Thus, the phrase “memory subsystem” is representative of various types of possible memory media within computer system 720. In some embodiments, the memory subsystem includes program instructions executable by processor subsystem 720 to perform embodiments of the sequence similarity assessment algorithms of the present disclosure.

Various embodiments of the sequence similarity assessment algorithm (described above) may include storing instructions and/or data implemented in accordance with the foregoing description in an article of manufacture such as a tangible computer-readable memory medium, including various portions of the memory subsystem of computer system 720. Certain embodiments of these tangible computer-readable memory media may store instructions and/or data that are computer executable to perform actions in accordance with the present disclosure. Generally speaking, such an article of manufacture may include storage media or memory media, such as magnetic (e.g., disk) or optical media (e.g., CD, DVD, and related technologies, etc.). The article of manufacture may be either volatile or nonvolatile memory. For example, the article of manufacture may be (without limitation) SDRAM, DDR SDRAM, SRAM, SanDisk, flash memory, and of various types of ROM, etc.

Further embodiment may include signals such as electrical, electromagnetic, or optical signals, conveyed via a communication medium, link, and/or system (e.g., cable, network, etc.), whether wired, wireless or both. Such signals may carry instructions and/or data implemented in accordance with the foregoing description.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method of rapidly assessing similarity between genomic sequences comprising:
building indices for reference sequence;
recording all local hits between a reference index and a query sequence in a local hit table;
identifying candidate entries in said local hit table for final alignment of said query to said reference; and
reporting assessing results.

2. The method of rapidly assessing similarity between genomic sequences of claim 1, wherein said reference indices are organized in list structures.

3. The method of rapidly assessing similarity between genomic sequences of claim 1, wherein said reference indices take an array form of data structure.

4. The method of rapidly assessing similarity between genomic sequences of claim 1, wherein said reference indices take a tree form of data structure.

5. The method of rapidly assessing similarity between genomic sequences of claim 1, wherein said reference indices take a form of gapless subsequences.

6. The method of rapidly assessing similarity between genomic sequences of claim 1, wherein said reference indices take a form of subsequences with gaps.

7. The method of rapidly assessing similarity between genomic sequences of claim 1, wherein said reference indices comprising forward and backward indices.

8. The method of rapidly assessing similarity between genomic sequences of claim 7, wherein
a forward index data structure is organized as a lexicographically sorted array of l base pairs prefixes;
each of said prefixes is pointing to a lexicographically sorted array of m base pairs suffixes;
each of said suffixes is associated with a numerically sorted array of l scaled k-bit masked locations of each of the l+m base pairs indexed entries, wherein k is distance mask size in bit; and
an optimal choice of l, m and k parameters depends on size and composition of said reference.

9. The method of rapidly assessing similarity between genomic sequences of claim 7, wherein
a backward index data structure is organized as a lexicographically sorted array of l base pairs prefixes;
each of said prefixes is pointing to a lexicographically sorted array of m base pairs suffixes;
each of said suffixes is associated with a numerically sorted array of l scaled k-bit masked locations of each of the l+m base pairs indexed entries, wherein k is distance mask size in bit; and
an optimal choice of l, m and k parameters depends on size and composition of said reference.

10. The method of rapidly assessing similarity between genomic sequences of claim 7, wherein when human genomic sequences are assessed, said l, m and k parameters are set as l=m=7 base pairs, and k=8 bit.

11. The method of rapidly assessing similarity between genomic sequences of claim 7, wherein one forward index and two backward indices with gaps are built wherein, one said backward index is with a gap of l base pairs and the other said backward index is with a gap of 2l base pairs.

12. The method of rapidly assessing similarity between genomic sequences of claim 7, wherein said forward or backward index works as a forward or backward tree to allow fast unwinding of low complexity regions and low error rate regions.

13. The method of rapidly assessing similarity between genomic sequences of claim 1, wherein said local hit table is organized by a process comprising:
determining a hit's distance in a query;
determining said hit's distance in a reference;
determining a difference of said hit's distance in said query and distance in said reference;
filling said hit in said local hit table according to its distance in a query against said difference; and
the time complexity of said local hits table building depends linearly on the size of said query.

14. The method of rapidly assessing similarity between genomic sequences of claim 13, wherein two local hit tables are built, one for said query and the other for its reverse complimentary sequence.

15. The method of rapidly assessing similarity between genomic sequences of claim 1, wherein the entries with highest number of hits (max entries) in said local hit table are identified as candidates for final alignment of said query and said reference.

16. The method of rapidly assessing similarity between genomic sequences of claim 15, wherein when the parameters are set as l=m=7 and k=8, a difference of at least 4 between the max entry (with highest number of hits) and second max entry makes said max entry a candidate for final alignment.

17. The method of rapidly assessing similarity between genomic sequences of claim 15, further comprising a process of selection of top hits from said local hits table:
converting said local hit table into a circularly connected linear buffer;
partitioning said linear buffer entries into two groups, one corresponding to the possible hits and the second to the random background hits;
processing said hit candidates group in greedy order;
selecting the entry with largest number of hits; and
terminating the process when a single entry is formed that clearly exceeds all other entries as well as the remaining hit candidates.

18. The method of rapidly assessing similarity between genomic sequences of claim 1, further comprising:
building a second local hit table;
filling from the leftmost part of the query into the local hit table; and
simultaneously filling from the rightmost part of the query into the second hit table.

19. The method of rapidly assessing similarity between genomic sequences of claim 1, further comprising:
building a second local hit table;
filling from the rightmost part of the query into the local hit table; and
simultaneously filling from the leftmost part of the query into a second hit table.

20. The method of rapidly assessing similarity between genomic sequences claimed in claim 18,
identifying a single significant alignment of an entry from either the local hit table or the second hit table; and
terminating the filling of local hit table and terminating the filling of second hit table in response of the identifying a single significant alignment.

21. The method of rapidly assessing similarity between genomic sequences claimed in claim 19,
identifying a single significant alignment of an entry from either the local hit table or the second hit table; and
terminating the filling of local hit table and terminating the filling of second hit table in response of the identifying a single significant alignment.

22. The method of rapidly assessing similarity between genomic sequences of claim 15, wherein said local hits table is used to deduce number, size and type of gaps including deletion and insertion, and genetic chimera by analyzing the max entries that are formed at different masked locations.

23. The method of rapidly assessing similarity between genomic sequences of claim 1, wherein said genomic sequences are DNA.

24. The method of rapidly assessing similarity between genomic sequences of claim 1, wherein said genomic sequences are RNA.

25. The method of rapidly assessing similarity between genomic sequences of claim 1, wherein said genomic sequences are human genomic sequences.

26. The method of rapidly assessing similarity between genomic sequences of claim 1, wherein said method is implemented with GPU or FPGA.
